(19) United States
(12) Patent Application Publication
(10) Pub. No.: US 2014/0037973 A1
(43) Pub. Date: Feb. 6, 2014

(54) Laser Imageable Non-Polyolefin Film

(71) Applicants: Rick Merical, Duncan, SC (US); Russell Darley, Simpsonville, SC (US); Patrick R. Thomas, Duncan, SC (US)

(72) Inventors: Rick Merical, Duncan, SC (US); Russell Darley, Simpsonville, SC (US); Patrick R. Thomas, Duncan, SC (US)

(73) Assignee: CRYOVAC, INC., Duncan, SC (US)

(21) Appl. No.: 13/565,898

(22) Filed: Aug. 3, 2012

(51) Int. Cl. C08K 3/10; B32B 27/32; B32B 27/36; B31B 1/62; C08L 53/02; C08L 67/03; B29C 59/16; B32B 27/34; C08L 77/00

(52) U.S. Cl. 428/474.4; 524/406; 428/523; 428/480; 264/400; 493/264

(57) ABSTRACT

The presently disclosed subject matter is directed generally to a polymeric film that comprises at least one laser imageable marking layer. The marking layer comprises a non-polyolefin component (such as polyamide, polyester, and/or polystyrene) and a photochromatic pigment. It has been discovered that a non-polyolefin film comprising a marking layer formulated with a photochromatic pigment offers a substantial advantage over prior art methods of laser imaging non-polyolefin films.

### FIELD OF THE INVENTION

The presently disclosed subject matter relates generally to polymeric films that can be laser imaged with text, symbols, and/or images. More specifically, the disclosed non-polyolefin film comprises at least one marking layer that comprises a photochromatic pigment.

### BACKGROUND

The identification marking of products is becoming increasingly important in almost every branch of industry. For example, it is often necessary to apply marks such as production dates, expiration dates, bar codes, company logos, serial numbers, images, and the like. Most of these markings are currently executed using conventional techniques, such as printing or labeling. However, contactless and rapid marking with lasers is gaining growing importance, especially for plastics. The use of lasers permits the high-speed application of graphics, bar codes, and the like without any additional pre-treatment of the plastic to improve adhesion. In addition, laser marked images are durable and abrasion-resistant, since they are within the body of the plastic film. Further, recently enacted regulatory requirements directed to pharmaceutical package identification and sterilization necessitate methods for tracking packages in potential recall or other similar situations. Laser marking can facilitate a cost effective means to accomplish these objectives.

Previously, many plastics have proven to be very difficult or even impossible to mark through the use of lasers. These include many common non-polyolefins, such as (but not limited to) polyamides, polyesters, and styrenes. Particularly, laser irradiation of such non-polyolefins, even at very high power, produces a weak, virtually illegible mark since the absorption coefficient is not sufficiently high to induce a color change.

In addition, when lasers are used to mark a non-polyolefin film, the pigment can overheat in the direct vicinity of the irradiation site and distort or decompose the plastic. Specifically, the definition of the image becomes distorted or irregular, thereby rendering the mark commercially less effective or completely useless.

Thus, the industry is in need of a marking solution that allows for a smaller unit of production with customized information that can be included on individual packages. Graphics changes with traditional printing methods have proven to be expensive and require longer lead times due to the printing plates and the generation of negatives. It is often difficult to achieve smaller order lots with traditional printing methods, such as flexography or rotogravure. The use of laser marking therefore potentially allows for economical methods of converting and allows the end user to reduce waste from aged or obsolete inventory and/or frequent change orders. The medical applications field is also beginning to require specific unit track and trace, which would follow the on-demand marking solution noted in the presently disclosed subject matter.

The disclosed laser-imageable non-polyolefin film provides high-contrast and good laser marking while simultaneously retaining a smooth, non-distorted surface.

### SUMMARY

In some embodiments, the presently disclosed subject matter is directed to polymeric film comprising a marking layer comprising a non-polyolefin component and a photochromatic pigment. The disclosed film can be marked by a laser in a wavelength range of about 300 to 11,000 nanometers.

In some embodiments, the presently disclosed subject matter is directed to a method of laser marking a polymeric film. The disclosed method comprises providing a polymeric film comprising a marking layer comprising a non-polyolefin component and a photochromatic pigment. The method also comprises exposing the film to a laser to produce an image on the film.

In some embodiments, the presently disclosed subject matter is directed to a method of making a package. The method comprises providing a polymeric film comprising a marking layer comprising a non-polyolefin component and a photochromatic pigment. The method further comprises sealing the multilayer film upon itself or to another film to form an enclosed package for a product. The disclosed film can be marked by a laser in a wavelength of from about 300 to 11,000 nanometers.

### DETAILED DESCRIPTION

### I. General Considerations

The presently disclosed subject matter is directed generally to a polymeric films that comprise at least one laser imageable marking layer. The marking layer comprises a non-polyolefin component and a photochromatic pigment. It has been surprisingly discovered that a non-polyolefin film comprising a marking layer formulated with a photochromatic pigment offers a substantial advantage over prior art methods of laser imaging non-polyolefin films.

### II. Definitions

While the following terms are believed to be well understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter belongs.

Following long standing patent law convention, the terms “a”, “an”, and “the” refer to “one or more” when used in the subject application, including the claims. Thus, for example, reference to “a film” includes a plurality of such films, and so forth.

Unless indicated otherwise, all numbers expressing quantities of components, reaction conditions, and so forth used in the specification and claims are to be understood as being modified in all instances by the term “about.” Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, percentage, and the like can encompass variations of, and in some embodiments, ±20%, in some embodiments ±10%, in some embodiments ±5%, in some embodiments ±1%, in some embodiments ±0.5%, and in some embodiments ±0.1%, from the specified amount, as such variations are appropriated in the disclosed package and methods.

The term “abuse layer” as used herein refers to an outer film layer and/or an inner film layer, so long as the film layer serves to resist abrasion, puncture, and other potential causes of reduction of package integrity, as well as potential causes of reduction of package appearance quality. Abuse layers can comprise any polymer so long as the polymer contributes to achieving an integrity goal and/or an appearance goal.

As used herein, the term “adjacent”, as applied to film layers, refers to the positioning of two layers of the film either in contact with one another without any intervening layer or with a tie layer, adhesive, or other layer therebetween. The term “directly adjacent” refers to adjacent layers that are in contact with another layer without any tie layer, adhesive, or other layer therebetween.

As used herein, the terms “barrier” and “barrier layer” as applied to films and/or film layers refer to the ability of a film or film layer to serve as a barrier to gases and/or odors, Examples of polymeric materials with low oxygen transmission rates useful in such a layer can include: ethylene/vinyl alcohol copolymer (EVOH), polyvinylidene dichloride (PVDC), vinylidene chloride copolymer such as vinylidene chloride/methyl acrylate copolymer, vinylidene chloride/vinyl chloride copolymer, polyamide, polyester, polyacrylonitrile (available as Barex™ resin), or blends thereof. Oxygen barrier materials can further comprise high aspect ratio fillers that create a tortuous path for permeation (e.g., nanocomposites). Oxygen barrier properties can be further enhanced by the incorporation of an oxygen scavenger, such as an organic oxygen scavenger. In some embodiments, metal foil, metallized substrates (e.g., metallized polyethylene terephthalate ((PET)), metallized polyamide, and/or metallized polypropylene), and/or coatings comprising SiOx or AlOx compounds can be used to provide low oxygen transmission to a package. In some embodiments, a barrier layer can have a gas (e.g., oxygen) permeability of less than or equal to about 500 cc/m²/24 hrs/atm at 73° F., in some embodiments less than about 100 cc/m²/24 hrs/atm at 73° F., in some embodiments less than about 50 cc/m²/24 hrs/atm at 73° F., and in some embodiments less than about 25 cc/m²/24 hrs/atm at 73° F.

The term “bulk layer” as used herein refers to a layer used to increase the abuse-resistance, toughness, modulus, etc., of a film. In some embodiments, the bulk layer can comprise polyolefin (including but not limited to) at least one member selected from the group comprising ethylene/alpha-olefin copolymer, ethylene/alpha-olefin copolymer plastomer, low density polyethylene, and/or linear low density polyethylene and polyethylene vinyl acetate copolymers.

The term “coating” as used herein refers to a substantially continuous outer layer of film or material to a substrate (such as a film). See, for example, U.S. Patent Application Publication No. 2008/0085318 and U.S. Pat. Nos. 7,829,258; 4,245,003; and 4,886,704, the entire contents of which are hereby incorporated by reference.

As used herein, the term “film” can be used in a generic sense to include plastic web, regardless of whether it is film or sheet. The term “film” can include embodiments wherein the film is a laminate, such as wherein a film comprising a marking layer is adhesively laminated to a transparent film layer.

The term “laser” as used herein refers generally to a category of optical devices that emit a spatially and temporally coherent beam of light otherwise known as a laser beam. In some embodiments, the term “laser” refers to conventional lasers (such as CO₂, YAG, and fiber lasers), as well as laser diodes. See, for example, the subject matter disclosed in U.S. Pat. Nos. 6,124,425; 7,193,771; 6,108,025; 6,064,416; and U.S. Patent Application Publication No. 2008/0164650, the entire contents of which are incorporated by reference herein.

The term “lidding film” refers generally to the film applied over a tray or bottom film to seal a tray or package. See, for example, U.S. Pat. Nos. 6,814,913; 6,602,590; and 6,503,549, the entire contents of which are incorporated by reference herein,

The term “marking layer” as used herein refers to the layer of a film that is marked or imaged by a laser. In some embodiments, the marking layer can be the skin layer of a film. Alternatively, the marking layer can be an inner film layer, such as in embodiments wherein the film includes a transparent coating layered over the marking layer.

The term “non-polyolefin” as used herein refers to any of a wide variety of non-polyolefin components. For example, in some embodiments, a non-polyolefin film can include (but is not limited to) any of a wide variety of polyamides, polyesters, and/or styrenes. In some embodiments, the term “non-polyolefin” can refer to a lack of polyolefin (i.e., no polyolefin is present).

The term “optical density” as used herein refers to a unitless value for the vibrancy of a printed image on a substrate. In some embodiments, the optical density refers to a gradation in gray levels between about 0.0 (fully transparent, fully reflective) to about 1.0 (black). Alternatively, in some embodiments, the practical minimum for a white paper can be about 0.0 and the practical maximum for black can be about 1.25 to 1.30.

As used herein, the term “peelable” refers to the capacity of a sealed lid or film to separate and release from sealed engagement with its underlying container while each substantially retains its integrity. Such separation and release can in some embodiments be achieved by a separating force applied manually to an outer edge portion of the sealed container.

The term “photochromatic” as used herein refers to the capability of darkening or changing color when exposed to light.

The term “pigment” as used herein refers collectively to all colorant particles known in the art. In some embodiments, the pigment can be an insoluble, organic, or inorganic colorant.

As used herein, the term “polyamide” refers to polymers having amide linkages along the molecular chain. Particularly, such terms encompass both polymers comprising repeating units derived from monomers (such as caprolactam) that polymerize to form a polyamide, as well as polymers of diamines and diacids, and copolymers of two or more amide monomers (including polyamide terpolymers, sometimes referred to in the art as “copolyamides”). The term “polyamide” also includes (but is not limited to) those aliphatic polyamides or copolyamides commonly referred to as nylon 6, nylon 66, nylon 69, nylon 610, nylon 612, nylon 4/6 nylon 6/66, nylon 6/69, nylon 6/610, nylon 66/610, nylon 6/12, nylon 6/12/66, nylon 6/66/610, nylon 6/12/66, nylon 69/66/61, nylon 10/10, nylon 11, nylon 12, nylon 6/12, modifications thereof and blends thereof. The term “polyamide” can also include crystalline, partially crystalline, amorphous, aromatic, and partially aromatic polyamides. Examples of partially crystalline aromatic polyamides include meta-xylylene adipamide (MXD6), copolymers such as MXD6/MXDI, 66/MXD10, and the like. Examples of amorphous polyamides nonexclusively include poly(hexamethylene isophthalamide-co-terephthalamide) (PA-6I/6T), poly(hexamethylene isophthalamide) (PA-6I), and other polyamides abbreviated as PA-MXDI, PA-6/MXDT/I, PA-6,6/6I and the like. Amorphous polyamides can also include polyamides that are prepared from the following diamines: hexamethylenediamine, 2-methylpentamethylenediamine, 2,2,4-trimethylhexamethylenediamine, 2,4,4-trimethylhexamethylenediamine, bis(4-aminocyclohexyl) methane, 2,2-bis(4-aminocyclohexyl)isopropylidine, 1,4-diaminocyclohexane, 1,3-diaminocyclohexane, meta-xylylenediamine, 1,5-diaminopentane, 1,4-diaminobutane, 1,3-diaminopropane, 2-ethyldiaminobutane, 1,4-diaminomethylcyclohexane, p-xylylenediamine, m-phenylenediamine, p-phenylenediamine, and alkyl substituted m-phenylenediamine and p-phenylenediamine.

The term “polyester” as used herein refers to a thermoplastic polymer in which the main polymer backbones are formed by the esterification condensation of polyfunctional alcohols and acids. This includes aromatic, aliphatic, saturated, and unsaturated di-acids and di-alcohols. The term “polyester” as used herein also includes copolymers (such as block, graft, random and alternating copolymers), blends, and modifications thereof. Examples of polyesters include (but are not limited to) polyethylene terephthalate (PET), polybutylene terephthalate (PBT), polytrimethylene terephthalate (PIT), polylactic acid (PLA), polyethylene terephthalate glycol” (PETG), and combinations thereof.

As used herein, the term “polymer” refers to the product of a polymerization reaction, and can be inclusive of homopolymers, copolymers, terpolymers, etc. In some embodiments, the layers of a film can consist essentially of a single polymer, or can have additional polymer together therewith, i.e., blended therewith.

As used herein, the term “polyolefin” refers to any polymerized olefin, which can be linear, branched, cyclic, aliphatic, aromatic, substituted, or unsubstituted. More specifically, included in the term “polyolefin” are homopolymers of olefin, copolymers of olefin, co-polymers of an olefin and a non-olefinic comonomer co-polymerizable with the olefin, such as vinyl monomers, modified polymers thereof, and the like. Specific examples include polyethylene homopolymer, polypropylene homopolymer, polybutene homo-polymer, ethylene alpha-olefin copolymer, propylene alpha-olefin copolymer, butene alpha-olefin copolymer, ethylene unsaturated ester copolymer, ethylene unsaturated acid co polymer, (e.g., ethylene ethyl acrylate copolymer, ethylene butyl acrylate copolymer, ethylene methyl acrylate copolymer, ethylene acrylic acid copolymer, and ethylene methacrylic acid copolymer), ethylene vinyl acetate copolymer, ionomer resin, polymethylpentene, etc.

As used herein, the phrases “seal layer”, “sealing layer”, “heat seal layer”, and “sealant layer”, refer to an outer film layer, or layers, involved in the sealing of the film to itself, another film layer of the same or another film, and/or another article that is not a film. It should also be recognized that in general, up to the outer 3 mils of a film can be involved in the sealing of the film to itself or another layer. In general, a sealant layer sealed by heat-sealing layer comprises any thermoplastic polymer. In some embodiments, the heat-sealing layer can comprise, for example, thermoplastic polyolefin, thermoplastic polyamide, thermoplastic polyester, and thermoplastic polyvinyl chloride.

As used herein, the term “skin layer” refers to an outer layer of a multilayer film used in a package containing a product, wherein the film is used to make the package so that the outer layer is an outside layer with respect to the package. Such outside outer film layers are subject to abuse during storage and handling of the packaged products.

As used herein, the term “styrene” refers to styrene per se, as well as styrene containing modifications, such as styrene butadiene copolymer” (SBC), a-methyl styrene, 3-chlorostyrene, 2,5-dichlorostyrene, 4-bromostyrene, 4-tert-butylstyrene, 4-methoxystyrene, vinyl naphthalene, vinyl toluene, and divinyl benzene.

As used herein, the term “tie layer” refers to an internal film layer having the primary purpose of adhering two layers to one another. In some embodiments, tie layers can comprise any nonpolar polymer having a polar group grafted thereon, such that the polymer is capable of covalent bonding to polar polymers such as polyamide and ethylene/vinyl alcohol copolymer. In some embodiments, tie layers can comprise at least one member selected from the group including, but not limited to, modified polyolefin, modified ethylene/vinyl acetate copolymer, and/or homogeneous ethylene/alpha-olefin copolymer. In some embodiments, tie layers can comprise at least one member selected from the group consisting of anhydride modified grafted linear low density polyethylene, anhydride grafted low density polyethylene, homogeneous ethylene/alpha-olefin copolymer, and/or anhydride grafted ethylene/vinyl acetate copolymer.

The term “transparent” as used herein can refer to the ability of a film, layer, or coating to transmit incident light with negligible scattering and little absorption, enabling objects (e.g., packaged food or print) to be seen clearly through the material under typical unaided viewing conditions (i.e., the expected use conditions of the material). The transparency of the material can be at least about any of the following values: 20%, 25%, 30%, 40%, 50%, 65%, 70%, 75%, 80%, 85%, and 95%, as measured in accordance with ASTM D1746.

All compositional percentages used herein are presented on a “by weight” basis, unless designated otherwise.

Although the majority of the above definitions are substantially as understood by those of skill in the art, one or more of the above definitions can be defined hereinabove in a manner differing from the meaning as ordinarily understood by those of skill in the art, due to the particular description herein of the presently disclosed subject matter.

### III. The Disclosed Film

III.A. Generally

The presently disclosed subject matter is directed generally to a polymeric film that comprises at least one marking layer such that the film is laser imageable. The marking layer comprises a non-polyolefin component and a photochromatic pigment. In some embodiments, the marking layer can be a skin layer.

The disclosed film can be monolayer or multilayer. To this end, the disclosed film can comprise from 1 to 20 layers; in some embodiments, from 2 to 12 layers; in some embodiments, from 2 to 9 layers; and in some embodiments, from 3 to 8 layers. Thus, in some embodiments, the disclosed film can have 1, 2, 3, 4, 5, 6, 7, 8, 9, 10, 11, 12, 13, 14, 15, 16, 17, 18, 19, or 20 layers. One of ordinary skill in the art would also recognize that the disclosed film can comprise more than 20 layers, such as in embodiments wherein the film comprises microlayering technology.

The disclosed film can have any total thickness so long as the film provides the desired properties for the particular packaging operation in which it is to be used. Nevertheless, in some embodiments the disclosed film can have a total thickness ranging from about 0.1 mil to about 15 mils; in some embodiments, from about 0.2 mil to about 10 mils; and in some embodiments, from about 0.3 mils to about 5.0 mils.

In some embodiments, at least a portion of the disclosed film can be irradiated to induce crosslinking. In the irradiation process, the film is subjected to one or more energetic radiation treatments, such as corona discharge, plasma, flame, ultraviolet, X-ray, gamma ray, beta ray, and high energy electron treatment, each of which induces cross-linking between molecules of the irradiated material. The irradiation of polymeric films is disclosed in U.S. Pat. No. 4,064,296, to Bornstein et al., which is hereby incorporated by reference in its entirety.

III.B. Marking Layer

As set forth above, the disclosed film includes at least one marking layer capable of being imaged when exposed to a laser. In some embodiments, the marking layer can be the skin layer of the film. Alternatively, in some embodiments, the marking layer can be an inner film layer. For example, in some embodiments, the marking layer can be an inner film layer and can be positioned adjacent to a transparent film layer or coating (such a layer comprising polypropylene, polyethylene, PET nylon, and the like). The marking layer comprises any of a wide variety of non-polyolefin components and a photochromatic pigment. For example, the non-polyolefin component can include (but is not limited to) polyamide, polyester, and/or styrene. In some embodiments, more than one non-polyolefin component can be incorporated into the marking layer of the disclosed film.

The non-polyolefin component can be present in the photochromatic pigment-containing marking layer in an amount of from about 60% to about 98%; in some embodiments, about 70% to about 95%; in some embodiments, about 80% to about 90%; and in some embodiments, from about 82% to about 88%, based on the total weight of the layer. Thus, in some embodiments, the non-polyolefin can be present in the marking layer in an amount of about 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, or 98%, based on the total weight of the layer.

Suitable photochromatic pigments that can be incorporated into the marking layer include any pigment that can form an image when exposed to laser radiation. Thus, any of a wide variety of commercially available laser markable pigments can be used, such as (but not limited to) Datalase™ (available from Datalase, Ltd., Cheshire, United Kingdom); Digilase™ (available from Directed Energy, Inc., Fort Collins, Colorado, United States of America); MARK-IT™ (available from Englehard Corp., Iselin, N.J., United States of America); PACKMARK™, CASEMARK™, GUARDMARK™, FOODMARK™, and PHARMAMARK™ (all available from Datalase, Ltd., Cheshire, United Kingdom); FAST-MARK™ (available from Polyone Corp., Avon Lake, Ohio, United States of America); CerMark™ (available from Cerdec Corp., Washington, Pa., United States of America); and Lazerflair™ (available from EMD Chemicals, Gibbstown, N.J., United States of America).

For example, in some embodiments, the pigment can be Datalase Pigment A, which forms a monochrome grey/black marking when exposed to a CO₂ laser or to a UV laser. One of ordinary skill in the art would recognize that suitable pigments are not limited to those that produce grey/black images and can also include pigments that incorporate at least one color into the marking layer. One of ordinary skill in the art would also recognize that more than one pigment can be included within the marking layer of the disclosed film.

In some embodiments, the pigment can be a metal, molybdenum, titanium, zinc, a polydiacetylene-based compound, a diacetylene-based compound, ammonium octamolybdate (AOM), another molybdenum compound, a vanadium compound, a tungsten compound, a compound containing a transitional metal, or any other material that can allow, promote, provide, or have a composition adequate for changing of color in response to an energy source such as a laser.

The pigment is present in the marking layer in a range of about 2% to about 40%; in some embodiments, about 5% to about 30%; in some embodiments, about 10% to about 20%; and in some embodiments, about 12% to about 18%, based on the total weight of the layer. In some embodiments, the amount of pigment present in the marking layer is about 2, 3, 4, 5, 6, 7 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40%, based on the total weight of the layer.

III.C. Additional Layers

In addition to the marking layer discussed herein above, the disclosed film can comprise one or more barrier layers, seal layers, tie layers, abuse layers, and/or bulk layers, as would be known to those of ordinary skill in the art. The polymer components used to fabricate the disclosed film can also comprise appropriate amounts of other additives normally included in such compositions. For example, slip agents, antioxidants, fillers, dyes, pigments and dyes, radiation stabilizers, antistatic agents, elastomers, and the like can be added to the disclosed films. See, for example, U.S. Pat. Nos. 7,205,040 to Peiffer at al.; 7,160,378 to Eadie at al.; 7,160,604 to Ginossatis; 6,472,081 to Tsai at al.; 6,222,261 to Horn at al.; 6,221,470 to Ciacca et al.; 5,591,520 to Migliorini at al.; and 5,061,534 to Blemberq at al., the disclosures of which are hereby incorporated by reference in their entireties.

### IV. Methods of Making the Disclosed Film

The presently disclosed film can be constructed by any suitable process known to those of ordinary skill in the art, including (but not limited to) coextrusion, lamination, extrusion coating, and combinations thereof. See, for example, U.S. Pat. No. 6,769,227 to Mumpower, the content of which is herein incorporated by reference in its entirety.

The pigment component of the marking layer can be mixed in any conventional manner. For example, in some embodiments, the pigment can be mixed with the polymer components of the marking layer by tumble or dry blending or by compounding in an extruder, followed by cooling. Masterbatching technology can also be employed.

### V. Methods of Using the Disclosed Film

As set forth in detail herein above, the presently disclosed subject matter is directed to a polymeric film that includes a marking layer comprising a non-polyolefin component and a photochromatic pigment. While it has proven difficult in the prior art to laser image non-polyolefin films, the disclosed film comprises a polychromatic pigment that facilitates laser imaging. In laser marking, radiation is directed onto the marking layer of a substrate film to modify the film in a way that induces a change that can be detected optically. Specifically, in some embodiments, the film is introduced into the beam path of a laser. The disclosed film is responsive to exposure to a laser beam by undergoing an irreversible color change. In some embodiments, the laser can be controllable by a computer that is programmed to project the laser beam in a predetermined pattern.

The laser can be a CO₂ laser, an Nd-YAG laser, and/or an excimer laser. However, the laser used is not limited and the disclosed film can be imaged using any of a wide variety of lasers known in the art, so long as the laser has a wavelength in the absorption range of the pigment used. The shade and depth of color obtained are determined by the laser parameters, such as irradiation time and output, as would be known to those of ordinary skill in the relevant art. For example, low energy densities lead to light markings in the film, while high energy densities lead to dark markings. The output of lasers used depends on the particular application and can readily be determined by the skilled worker in each individual case. For example, in some embodiments, the disclosed film can be marked by a laser in a wavelength range from about 300 to 11,000 nm. Thus, the disclosed film can be marked by a laser in a wavelength range of about 300, 350, 400, 450, 500, 550, 600, 650, 700, 750, 800, 850, 900, 1000, 1250, 1500, 1750, 2000, 2250, 2500, 2750, 3000, 3250, 3500, 3750, 4000, 4250, 4500, 4750, 5000, 5250, 5500, 5750, 6000, 6250, 6500, 6750, 7000, 7250, 7500, 7750, 8000, 8250, 8500, 8750, 9000, 9250, 9500, 9750, 10000, 10250, 10500, 10750, or 11000 nm.

One example of a suitable laser is a Videojet 3320 laser marking system commercially available from Videojet Technologies of Wood Dale, Ill., United States of America. The laser marking system includes a sealed-off CO₂ laser rated at an output of 30 Watts and a 10.6 μm wavelength with a SHC 60 focusing lens. It should be noted that other types of CO₂ lasers, fiber lasers, laser diodes, laser diode arrays, UV lasers, near infrared diode lasers, YAG lasers, arrays of other lasers (e.g., CO₂ lasers) or other lasers with sufficient power and fluence to change the color of a coating can be used. For example, in some embodiments, the energy source can be configured to change the color of the pigment by changing an oxidization state of the pigment, by polymerizing the pigment, by breaking an encapsulant to release a dye in the pigment, and/or by changing a phase of the pigment.

The radiation can be directed in a pattern over the substrate film such that a desired indicia or image is rendered. Particularly, variable and/or fixed data (i.e., text and/or graphics) can be printed. In addition, the image can be printed in color or monochrome (e.g., black). The image can include variable data, which can comprise geographic, demographic, postal, personal, and/or book data, or any combination of these types of information and other types of information not specifically identified here. In addition, the variable data can comprise bar codes representing certain data or other information, such as address data, universal product code (UPC) data, price data, or other data.

The disclosed film can be used in all sectors where customary printing processes have previously been employed for the imaging of plastics. For example, in embodiments where the substrate is used as a packaging film, the packaging can be any material used to pack or label a product, such as a lidding film for a food or medical package. In some embodiments, the lidding film can be peelable. Thus, the disclosed film can be converted into a package according to standard methods known in the art. See, for example, U.S. Pat. Nos. 6,686,006; 6,250,048; 4,751,808; 4,727,707, and U.S. Patent Application Publication No. 2007/0167123, the entire disclosures of which are incorporated by reference herein.

The marking of the disclosed film is characterized by a very high quality of imaging with minimal film distortion. In some embodiments, the optical density of the disclosed film can be from about 0.5 to about 1.25; in some embodiments, from about 0.6 to about 1.15; in some embodiments, from about 0.7 to about 1.0; and in some embodiments, about 0.65 to about 0.90, based on a 0.0 (white) to 1.25 (black) ODB scale. Thus, in some embodiments, the disclosed film can have an optical density of about 0.500, 0.525, 0.550, 0.575, 0.600, 0.625, 0.650, 0.675, 0.700, 0.725, 0.750, 0.800, 0.825, 0.850, 0.875, 0.900, 0.925, 0.950, 0.975, 1.00, 1.025, 1.050, 1.075, 1.100, 1.125, 1.150, 1.175, 1.200, 1.225, or 1.250. Optical density is defined as the amount of light reflected from the test specimen under specific conditions. In some embodiments, the optical density can be measured using ASTM E1349 spectral conditions.

The text is clearly legible and is distinguished by a high degree of resolution. Overall, the marking is of pleasing appearance and is capable of matching a packaging design well. Because laser imaging is performed using non-contact methods with a relatively large distance between the laser and the film, packages that are already filled and sealed can be marked without any problems. Moreover, the integration of a marking unit within a packaging plant has the advantage that the production process can be substantially more flexible. In addition, it has been shown that after sterilization the marking remains clearly legible and is not subject to changes.

Although the disclosed films can be sealed to themselves to form a sealed package (for example, as in the VFFS or HFFS packaging methods known in the art), in some embodiments, the disclosed films can be sealed to a substrate in one or more selected areas (e.g., perimeter) to form a sealed package. In some embodiments, the substrate can be flexible or rigid. In some embodiments, the substrate can be a monolayer substrate film or a multilayer substrate film, such as those thermoplastic films used as the formed web (e.g., “bottom” web) of the thermoforming or vacuum skin packaging methods known in the art. In some embodiments, the substrate can include a flexible or rigid metal (e.g., aluminum foil) or cellulosic (e.g., paper) flexible substrate.

In some embodiments, the substrate can comprise a monolayered or multilayered rigid support, such as a plastic or corrugated backing board having a surface film layer, coating or other modification to facilitate sealing to the film, or rigid tray having perimeter flange with a similar film layer, coating or modification at least in the flange area to facilitate sealing to the film. The rigid trays or supports can be formed from thermoset plastics, thermoplastics (e.g., expanded polystyrene sheet material which has been thermoformed into a desired shape), cellular or foamed plastics (e.g., extruded polystyrene foam sheet), metal, and/or combinations thereof.

### VI. Advantages of the Disclosed Film

The presently disclosed subject matter provides for laser imaging of non-polyolefin films. As a result, the disclosed film and methods can replace conventional inkjet, digital, thermal ribbon transfer, web-based or gravure-based printing processes.

The disclosed methods therefore reduce printing time, improve efficiency, reduce the costs associated with inks, and provide greater flexibility compared to prior art imaging methods. In addition, the disclosed method does not require formulating, cleaning, and provides for reduced scrap with no changeover required. Further, transitions between films are automatic and the lasers are capable of changing images instantly.

The disclosed film and methods are also more sustainable compared to prior art marking methods. Specifically, the use of printing solvents as well as related VOC (volatile organic compounds) are eliminated using the disclosed methods.

Further, customers using the disclosed system and methods can customize packaging for specific lot traceability as required for many pharmaceutical products that require every unit to be controlled and traceable. Prior art methods require the use of expensive pressure-sensitive labels for each package.

In addition, laser marked articles can be safely employed in packaging for foodstuffs, medical uses, and the like. These markings on packaging are wipe-resistant, scratch-resistant, stable during subsequent sterilization processes, and applied in a hygienically pure manner during the marking process.

### EXAMPLES

The following Examples provide illustrative embodiments. In light of the present disclosure and the general level of skill in the art, those of ordinary skill in the art will appreciate that the following Examples are intended to be exemplary only and that numerous changes, modifications, and alterations can be employed without departing from the scope of the presently disclosed subject matter.

Several film structures in accordance with the presently disclosed subject matter and comparatives are identified herein below in Tables 1 and 2.

TABLE 1
Resin Identification

| | Trade Name or | |
|---|---|---|
| Material Code | Designation | Source |
| A | Grilon CF6S | EMS-Grivory (Domat, |
| | | Switzerland) |
| B | Stryrolux 3G55 | Styrolution USA, LLC |
| | | (Florham Park, New |
| | | Jersey, United States of |
| | | America) |
| C | Eastar Copolyester 5011 | Eastman Chemical Co. |
| | | (Kingsport, Tennessee, |
| | | United States of America) |
| D | Datalase Pigment A | Datalase, Ltd. (Widnes, |
| | | United Kingdom) |

A is a polyamide 6/12 with a melt index of 200 g/10 min, density of 1.05 g/cc, and melting point of 510° F.
B is a styrene-butadiene block copolymer with a melt index of 15 g/10 min. and melting point of 374-446° F.
C is a glycol modified polyethylene terephthalate (GPET) with density of 1.28 g/cc and melting point of 480° F. (processing temperature).
D is a photochromatic pigment with melting point of 200° C. and 0.5 micron particle size.

TABLE 2
Film Identification

| Film ID | Layer | Formulation | Volume % | Mils |
|---|---|---|---|---|
| Film 1 | 1 | 85% A | 100 | 5 |
| | | 15% D | | |
| Film 2 | 1 | 85% B | 100 | 5 |
| | | 15% D | | |
| Film 3 | 1 | 85% C | 100 | 5 |
| | | 15% D | | |

### Example 1

### Preparation of Films 1-3

Films 1-3, with the compositions and constructions shown in Table 2, were prepared using a Leistritz Twin Screw Extruder, flat cast die, and side stuff additive feeder with the extrusion conditions listed below in Tables 3A-3C.

TABLE 3A
Extrusion Conditions - Film 1

| | No. | ° C. |
|---|---|---|
| Barrel Temperature | 1 | 180 |
| | 2 | 182 |
| | 3 | 182 |
| | 4 | 182 |
| | 5 | 182 |
| | 6 | 182 |

| | |
|---|---|
| RPM | 100 |
| AMPS | 84% |
| Press (PSI) | 260 |

| | | |
|---|---|---|
| Feeder | Material A Feeder | 30 gpm |
| | Material D Feeder | 5.4 gpm |

TABLE 3B
Extrusion Conditions - Film 2

| | No. | ° C. |
|---|---|---|
| Barrel Temperature | 1 | 178 |
| | 2 | 180 |
| | 3 | 180 |
| | 4 | 180 |
| | 5 | 180 |
| | 6 | 180 |

| | |
|---|---|
| RPM | 100 |
| AMPS | 78% |
| Press (PSI) | 400 |

| | | |
|---|---|---|
| Feeder | Material B Feeder | 34 gpm |
| | Material D Feeder | 6 gpm |

TABLE 3C
Extrusion Conditions - Film 3

| | No. | ° C. |
|---|---|---|
| Barrel Temperature | 1 | 188 |
| | 2 | 190 |
| | 3 | 190 |
| | 4 | 190 |
| | 5 | 190 |
| | 6 | 190 |

| | |
|---|---|
| RPM | 100 |
| AMPS | 95% |
| Press (PSI) | 240 |

| | | |
|---|---|---|
| Feeder | Material B Feeder | 30 gpm |
| | Material D Feeder | 5 gpm |

### Example 2

### Imaging of Films 1-3

1 cm×1 cm square samples of Films 1-3 were prepared. Each sample was imaged using a Videojet 3320 CO2 laser (available from Videojet Technologies Inc., Wood Dale, Ill., United States of America) with a SCH60 marking head, ML 120001 (127 mm) focusing lens, and x2 beam expander. The VideoJet extraction unit was Model Advantage Oracle (SN: Oracle 3348), and the label software was Smartgraph (6.9.0). The imaging parameters are set forth in Table 4 below.

| | | | Index #3 |
|---|---|---|---|
| | Index #1 (Text/ | Index #2 (2-D | (EAN-13 |
| | Lines/Graphics) | Datamatrix) | Barcode) |
| Marking Speed | 1700 | 2000 | 2000 |
| (mm/s) | | | |
| Marking Intensity | 60 | 55 | 55 |
| (%) | | | |
| Line width (mm) | 0.187 | 0.200 | 0.187 |
| Resulting label | 1.56 | 1.56 | 1.56 |
| print time (sec) | | | |

It was observed that all resins (A, B, and C) were successfully compounded with 15% component D (pigment). It was also observed that Films 1-3 provided good legibility without any film deformation issues when imaged with a VideoJet CO2 laser.

What is claimed is:

1. A polymeric film comprising a marking layer comprising:
a. a non-polyolefin component; and
b. a photochromatic pigment;
wherein said film can be marked by a laser in a wavelength range from about 300 to 11,000 nm.

2. The film of claim 1, wherein said non-polyolefin component is selected from the group consisting of: polyamide, polyester, polystyrene, and combinations thereof.

3. The film of claim 1, wherein said pigment is ammonium octamolybdate.

4. The film of claim 1, wherein the pigment is present in the marking layer in an amount of about 10% to about 20%, based on the total weight of the layer.

5. The film of claim 1, further comprising a transparent layer or coating positioned adjacent to or directly adjacent to said marking layer.

6. The film of claim 1, wherein said film is a laminate comprising a transparent film layer.

7. A package comprising the film of claim 1.

8. A method of laser marking a polymeric film, said method comprising:
a. providing a polymeric film comprising a marking layer comprising:
i. a non-polyolefin component; and
ii. a photochromatic pigment; and
b. exposing said film to a laser in a wavelength range from about 300 to 11,000 nm to produce an image on the film.

9. The method of claim 8, wherein said non-polyolefin component is selected from the group consisting of: polyamide, polyester, polystyrene, and combinations thereof.

10. The method of claim 8, wherein said pigment is ammonium octamolybdate.

11. The method of claim 8, wherein the pigment is present in the marking layer in an amount of about 10% to about 20%, based on the total weight of the layer.

12. The method of claim 8, wherein said image is black.

13. The method of claim 8, wherein said image is single-colored or multi-colored.

14. A method of making a package, said method comprising:
a. providing a polymeric film comprising a marking layer comprising:
i. a non-polyolefin component; and
ii. a photochromatic pigment; and
b. sealing said multilayer film upon itself or to another film to form an enclosed package for a product;
wherein said polymeric film can be marked by a laser in a wavelength range from about 300 to 11,000 nm.

15. The method of claim 14, wherein said film is a peelable lidding film.
